(19) United States
(12) Patent Application Publication
(10) Pub. No.: US 2011/0040581 A1
(43) Pub. Date: Feb. 17, 2011

(54) LIFE SPAN SOLUTION-BASED MODELING

(75) Inventor: Richard J. Wirth, West Hartford, CT (US)

Correspondence Address: MCCORMICK, PAULDING & HUBER LLP, CITY PLACE II, 185 ASYLUM STREET, HARTFORD, CT, 06103, US

(73) Assignee: Hartford Fire Insurance Company, Hartford, CT (US)

(21) Appl. No.: 12/542,249

(22) Filed: Aug. 17, 2009

(51) Int. Cl. G06Q 40/00

(52) U.S. Cl. 705/4; 705/36 R

(57) ABSTRACT

A computer-implemented simulation calculates financial consequences and likelihoods for a large number of potential real life events based on demographic data and based on an individual's responses to a questionnaire, in order to predict which types of financial products might best serve the individual's long term needs based on market trends extrapolated from historical market data. The computer-implemented simulation model provides an objective, non-speculative basis for recommending financial products that are most likely to meet the individual's present and future financial needs. The model assumes that any number of different products can satisfy customer needs for matters such as wealth generation, wealth and social status preservation, wealth transfer, or charitable giving. The model also factors whether existing and anticipated funding sources are to be dispensed in the form of a sinking or sustainable fund. Product affordability is also taken into consideration.

### FIELD OF THE INVENTION

The present invention relates to computer-implemented investment systems and methods and, more particularly, to systems and methods for predictive estimation of optimal wealth management portfolios.

### BACKGROUND OF THE INVENTION

For simplicity, customers typically seek to allocate their financial assets into a single investment vehicle that can assure their present and long term financial needs. Unfortunately, current regulatory constraints effectively prevent the development of a single product that can consistently match customer needs and aspirations. For example, needs based selling regulations constrain producers from speculative recommendations of products that do not serve an existing or impending financial goal. The vague and subjective standard for “impending” causes avoidance of any recommendations that might be seen as speculative. Additionally, no single investment vehicle is presently available that can be expected to provide a predictably varying risk/return profile over the long term. As a result, financial planners are not able to recommend any single investment vehicle that will meet their customers' long term needs. Instead, financial planners must ladder and otherwise transition different investment vehicles based on their customers' own best estimates of future needs and risk tolerance.

Accordingly, it is desirable to provide an improved system and method for objectively estimating an individual's near term and long term financial needs, and determining which financial products are most likely to meet the individual's present and future financial needs.

### BRIEF SUMMARY OF THE INVENTION

According to an embodiment of the present invention, a computer-implemented simulation model calculates financial consequences and likelihoods for a large number of potential real life events based on demographic data and based on an individual's responses to a questionnaire, in order to predict which types of financial products might best serve the individual's long term needs based on market trends extrapolated from historical market data. This needs based modeling assumes that any number of different products can satisfy customer needs for matters such as wealth generation, wealth and social status preservation (e.g., retirement funding), wealth transfer (e.g., death benefits), or charitable giving. The model would also factor whether existing and anticipated funding sources (e.g., income earned, asset appreciation, inheritance, etc.) are to be dispensed in the form of a sinking or sustainable fund. Product affordability is also taken into consideration. Accordingly, the computer-implemented simulation model provides an objective, non-speculative basis for recommending financial products that are most likely to meet the individual's present and future financial needs.

According to an embodiment of the present invention, a computer system for life span solution-based modeling of recommended instructions for allocating investment inputs includes a data storage structure and a computer processor configured to read from the data storage structure a plurality of individual responses to a standardized questionnaire, a set of demographic data, a plurality of market priors, and characteristics of a plurality of investment vehicles, correlate at least part of the set of demographic data to the individual responses, calculate a plurality of sequences of possible life events based on the individual responses and the demographic data, and a plurality of sequences of possible market trends based on the market priors, further calculate a time-varying individual need based on the plurality of possible sequences of life events and the plurality of sequences of possible market trends, and establish an optimal sequence of instructions for allocating investment inputs based on the time-varying individual need, the characteristics of the plurality of investment vehicles, and the plurality of possible market trends, wherein the investment vehicles include fixed annuities, tax-deferred investments, mutual funds, direct equity investments, secured lending instruments, variable annuities, variable universal life insurance, term life insurance, property and casualty insurance, and umbrella liability insurance.

One aspect of the present invention is that the computer system for life span solution-based modeling of recommended instructions for allocating investment inputs also would accept various data input parameters and business rules that would be used to develop decision trees. By changing the values of the input parameters, the financial planner can do “what-if” studies to see what happens when the inputs change on a current and long-term basis.

Another aspect of the present invention is that the results generated by the computer system for life span solution-based modeling of recommended instructions for allocating investment inputs can be represented and displayed as probability distributions (or histograms) or pie charts. These depictions also can include descriptions of assumptions used to develop the simulation, reliability predictions, margins of error, and degrees of confidence regarding the simulation results.

A further aspect of the present invention is that the computer system for life span solution-based modeling of recommended instructions for allocating investment inputs would utilize a Monte Carlo simulation method for iteratively evaluating random data inputs such as assumed inflation rates, earning potential, market movements, portfolio returns, and the desired method of funding expected personal and family needs. A Monte Carlo simulation method is preferred because such a model is complex, nonlinear, and combines a large number of uncertain parameters.

A further aspect of the present invention is that the computer system for life span solution-based modeling of recommended instructions for allocating investment inputs can automatically repeat the calculation of financial consequences and likelihoods for a large number of potential real life events based on demographic data and based on the individual's previous or updated responses to the questionnaire, at predefined time intervals, in order to update the system's predictions as to which types of financial products might best serve the individual's long term needs based on market trends extrapolated from historical market data.

Yet another aspect of the present invention is that, based on periodic automatic updates of the calculated financial consequences and likelihoods, the computer system can automatically reallocate investment assets among various investment vehicles at the predefined time intervals, so as to better meet the individual's present and future financial needs.

These and other objects, features, and advantages of the present invention will become apparent in light of the detailed description of the best mode embodiment thereof, as illustrated in the accompanying drawings.

### BRIEF DESCRIPTION OF THE DRAWINGS

FIG. 1 is a schematic diagram of a system for life span solution-based modeling of recommended investment input allocations, according to an embodiment of the present invention;

FIG. 2 is a schematic diagram of the system of FIG. 1, implemented using a standalone server computer;

FIG. 3 is a schematic diagram of the system of FIG. 1, implemented using a distributed network architecture;

FIG. 4 is a flowchart illustrating a process for life span solution-based modeling of recommended investment input allocations, according to an embodiment of the present invention;

FIG. 5 is a bar chart illustration of an optimal sequence of investment allocations, according to an embodiment of the present invention;

FIG. 6 is a table of criteria for adjusting recommended investment allocations, according to an embodiment of the present invention;

FIG. 7 is a pie chart illustration of an optimal sequence of investment input allocations, labeled by investment purpose, according to an embodiment of the present invention; and

FIG. 8 is a pie chart illustration of an optimal sequence of investment input allocations, labeled by investment vehicle, according to an embodiment of the present invention.

### DETAILED DESCRIPTION OF PREFERRED EMBODIMENTS

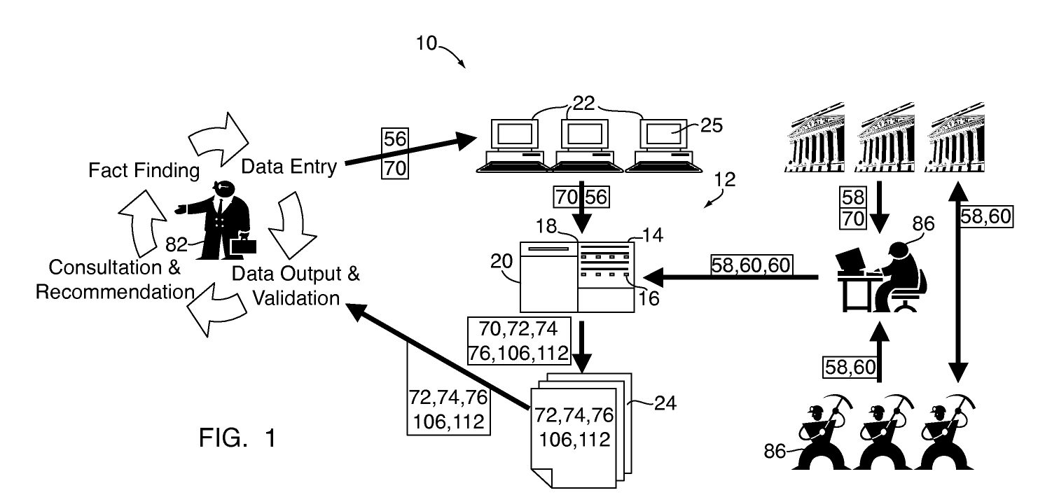

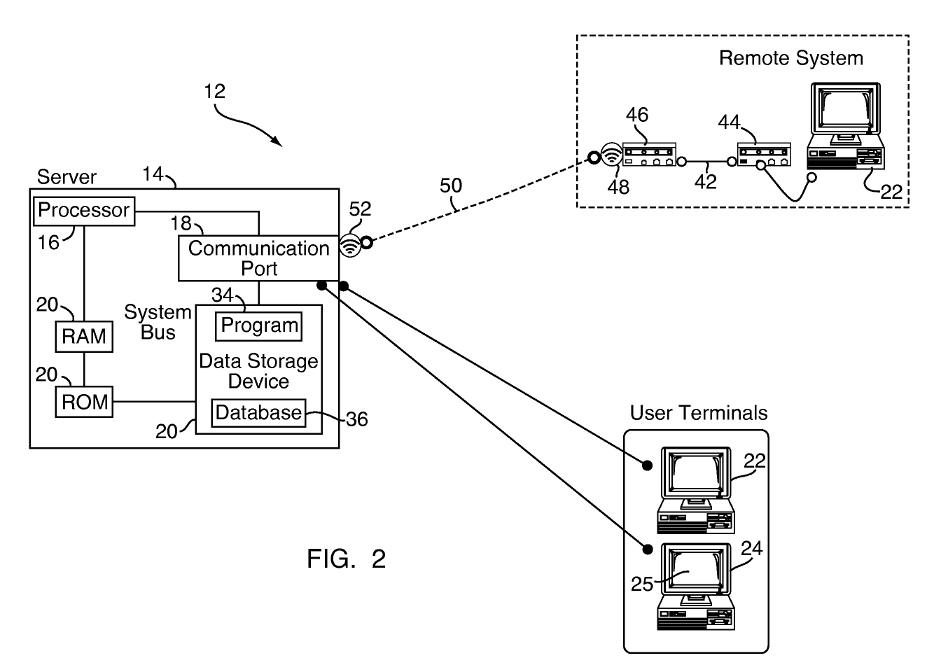

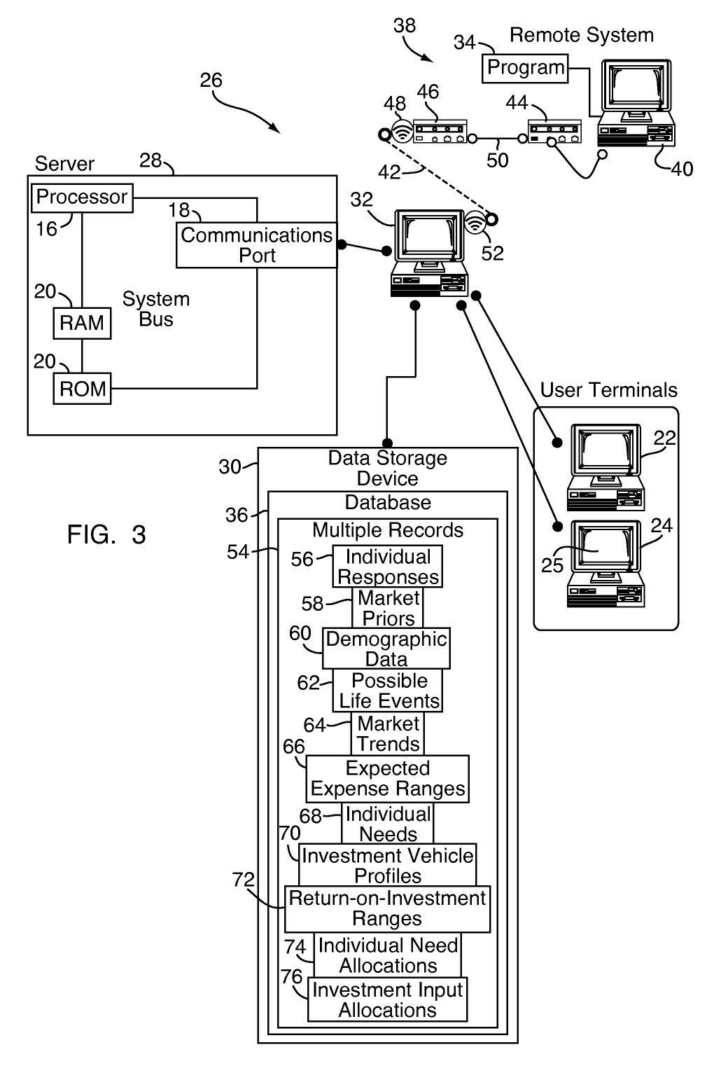

Referring to FIG. 1, a process 10 for periodic rebalancing of investment input allocations among investment vehicles is implemented in a network computer system 12, using a life-span-solution-based modeling approach. The network computer system 12 may be configured in many different ways. For example, the system 12 may include a conventional standalone server computer 14, as shown in FIG. 2. Alternatively, the system 12 can be configured in a distributed architecture 26, as shown in FIG. 3.

Referring to FIG. 2, the conventional standalone server computer 14 includes at least one controller, processor, or central processing unit (CPU) 16, at least one communication port 18, and at least one data storage structure 20. The processor 16 may include one or more conventional microprocessors and one or more supplementary co-processors such as math co-processors. The communication port 18 may include multiple communication channels for simultaneous communication with, for example, other processors, servers or client terminals 22, or a display unit 24, any of which may be configured to provide various user interfaces 25, such as an investment platform interface for purchasing of investment vehicles. Devices in communication with each other need not be continually transmitting to each other. On the contrary, such devices need only transmit to each other as necessary, may actually refrain from exchanging data most of the time, and may require several steps to be performed to establish a communication link between the devices. For example, the communication port 18 may include wire modems, wireless radio, infrared, visible laser, or UV laser transceivers, or audio transceivers. The communication port 18 and the at least one data storage structure 20 are in communication with the processor 16 to facilitate the operation of the network server 14. The data storage structure 20 may comprise an appropriate combination of magnetic, optical and/or semiconductor or flash memory, and may include, for example, RAM, ROM, an optical disc such as a compact disc and/or a hard disk or drive. The processor 16 and the data storage structure 20 each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wireline medium.

Each user device or computer or client terminal 22 may include any one or a combination of a keyboard, a computer display, a touch screen, LCD, voice recognition software, an optical or magnetic read head, or other input/output devices required to implement the above functionality.

Each display unit 24 may include any one or a combination of a computer display, a printer, a CD/DVD burner, a magnetic tape drive, a magnetic disk drive, an LCD array, a voice speaker, a network connection, or similar output device.

Referring to FIG. 3, the distributed network architecture 26 includes several distributed servers 28 and at least one data storage device 30. Each distributed server 28 includes a processor 16 and a data storage structure 20. The distributed servers 28 and the data storage device 30 are in communication with a communications hub or port 32 that serves as a primary communication link with other servers, client or user terminals 22 and other related devices including one or more display units 24. The communications hub or port 32 may have minimal processing capability itself, serving primarily as a communications router, or may also act as another distributed server 28. A variety of communications protocols may be part of the system, including but not limited to: Ethernet, SAP, SAS.™., ATP, Bluetooth, and TCP/IP.

At least one of the data storage structures 20 or the data storage device 30 is encoded with (i) a program and/or algorithm(s) 34 (e.g., computer program code and/or a computer program product) adapted to configure one or more of the processors 16 to perform the computerized process 10 for life span solution-based modeling of recommended investment input allocations, as described in detail hereinafter; and/or (ii) at least one database 36 configured to store information required, manipulated, or produced by one or more of the processors 16 according to the computerized process 10 described by the program 34.

The computer program 34 for configuring the processor 16 to implement the process 10 (and other functions described herein) can be developed by a person of ordinary skill in the art, and is not described in detail herein. Suitable computer program code may also be provided for performing numerous other functions such as generating notifications at selected time intervals. For example, in addition to instructions for configuring the processor 16 to perform the process 10, the program 34 also may include program elements such as an operating system, a database management system and “device drivers” that allow the processor to interface with computer peripheral devices (e.g., a video display, a keyboard, a computer mouse). The instructions of the program 34 may be read by the processor 16 from the data storage structure 20. The program 34 may be stored, for example, in a compressed, an uncompiled and/or an encrypted format, and may include computer program code. While execution of sequences of instructions in the program 34 will cause the processor 16 to perform the steps of the computerized process 10 as described below, hard-wired circuitry may be used in place of, or in combination with, software instructions for implementation of the computerized process 10. Thus, embodiments of the present invention are not limited to any specific combination of hardware and software.

Alternatively, as shown in FIG. 3, the program 34 may be embodied in another computer-readable medium 38 that provides or participates in providing instructions to the processor 16 (or any other processor of a computing device described herein) for execution. The computer-readable medium 38 may take many forms, including but not limited to, non-volatile media, volatile media, and transmission media. Non-volatile media include, for example, optical or magnetic disks, such as memory. Volatile media include dynamic random access memory (DRAM), which typically constitutes the main memory. Transmission media include coaxial cables, copper wire and fiber optics, including the wires that comprise a system bus coupled to the processor. Transmission media may carry acoustic or light waves, such as those generated during radio frequency (RF) and infrared (IR) data communications. Common forms of computer-readable media 38 include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave encoded with data by amplitude, phase, and/or frequency modulation, or any other medium from which a computer can read.

Various forms of the computer-readable medium 38 may be involved in configuring the processor 16 (or any other processor of a device described herein) to perform the computerized process 10. For example, as shown in FIG. 3, the program 34 may initially be borne on a magnetic disk of a remote computer 40. The remote computer 40 can load the instructions into its dynamic memory and send the instructions over a telephone line 42 using a first modem 44. A second modem 46 local to a computing device (e.g., the server 14) can receive the data on the telephone line 42 and use an infrared transmitter 48 to convert the data to a wireless signal 50. An infrared detector 52 can receive the data carried in the wireless signal 50 and transfer the data through the communication port 18 to the processor 16. In addition, instructions may be received via the communication port 18 as electrical, electromagnetic or optical signals, conveyed either on optical or electromagnetic cables or as wireless carrier waves that carry data streams representing various types of information.

The database 36 may include multiple records 54, each record including fields specific to the present invention such as but not limited to individual responses 56, market priors 58, demographic data 60, possible life events 62, market trends 64, expected expense ranges 66, individual needs 68, profiles of investment vehicles 70, return-on-investment ranges 72, individual need allocations 74, instructions for allocating investment inputs 76, and associated probabilities and time sequencing data. The investment vehicles 70 can include fixed annuities, tax-deferred investments, mutual funds, direct equity investments, secured lending instruments, variable annuities and other sorts of “longevity insurance”, variable universal life insurance, term life insurance, educational savings plans, property and casualty insurance, and umbrella liability insurance.

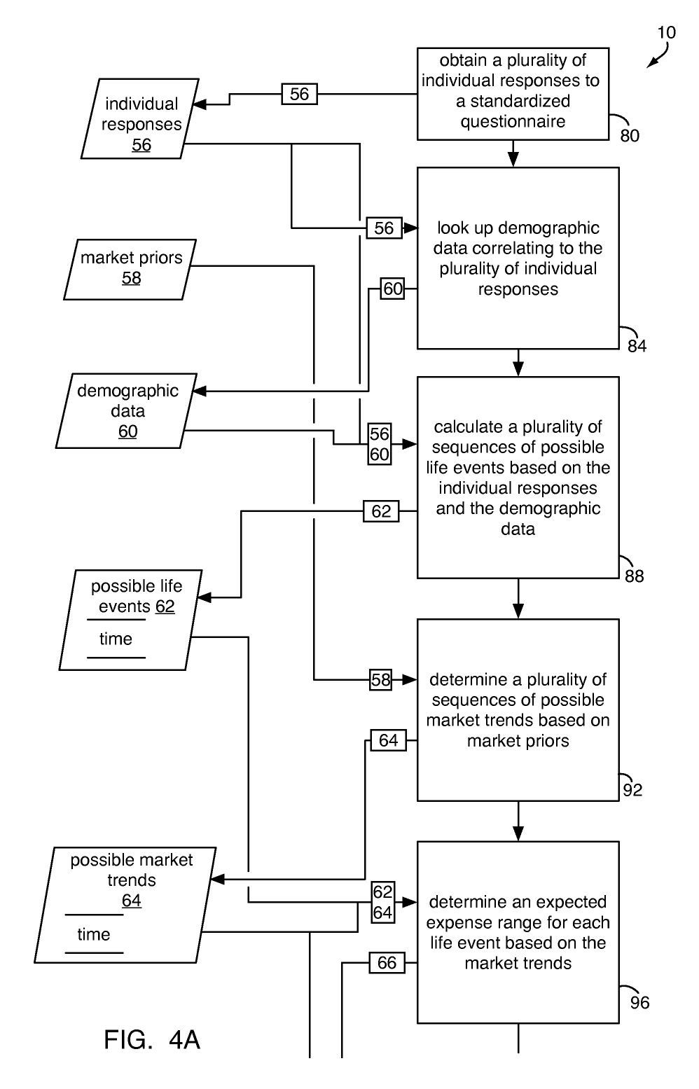

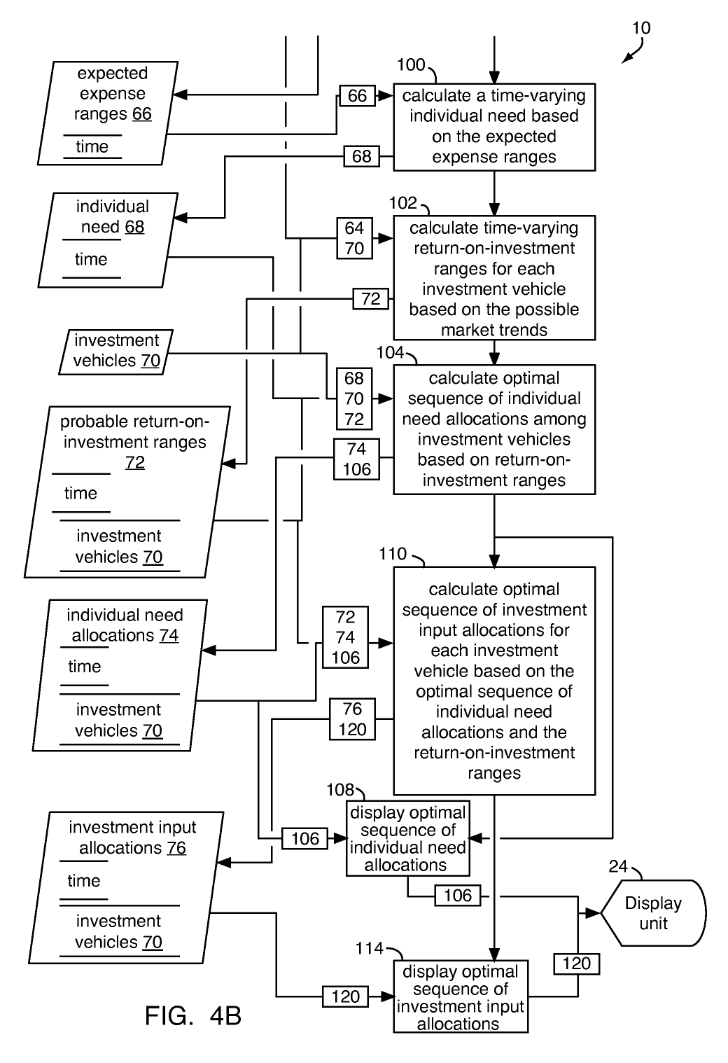

In operation, as shown in FIGS. 1 and 4, the computerized process 10 for life span solution-based modeling of recommended instructions for allocating investment inputs includes a plurality of steps implemented by the system 12. At a step 80 of the computerized process 10, as shown in FIG. 4, the system 12 receives a plurality of individual responses 56 to a standardized questionnaire and provides the plurality of individual responses 56 to the processor 16. The plurality of individual responses 56 can be obtained directly by interaction of an individual with the system 12, or can be previously entered into the data storage structure 20 by a financial advisor 82, as shown in FIG. 1. The financial advisor 82 may be an individual, a corporation, or any other legal entity. Administration of the standardized questionnaire can optionally be included in the computerized process 10. Preferably, whatever standardized questionnaire is used provides an array of predetermined numeric or multiple-choice responses such that the individual responses 56 can easily be data coded for correlation with demographic data 60 encoded into the data storage structure 20.

At a step 84, the processor 16 uses the individual responses 56 to look up, correlate, or otherwise identify relevant demographic data 60, previously developed by data miners 86. Preferably, the data storage structure 20 is encoded with a large set of demographic data 60 tagged according to the degree of correlation of each data element with each of the predetermined responses.

At a step 88, the processor 16 calculates a plurality 90 of possible sequences of life events 62 based on the individual responses 56 and the demographic data 60, as shown by the boxed labels and arrows in FIG. 4. Preferably, Monte Carlo analysis is used to generate the plurality 90 of possible sequences of life events 62. A Monte Carlo simulation method is preferred because such a model is complex, nonlinear, and combines a large number of uncertain parameters. Monte Carlo analysis can include random assessment of input variables such as earning potential, timing of children's education, likelihood of major purchases, and other individual and family life events bounded by the demographic data 60. The individual responses 56 also can be used to “force” the Monte Carlo analysis of possible life events 62.

At a step 92, the processor 16 determines a plurality 94 of possible sequences of market trends 64 based on the market priors 58 previously compiled by the data miners 86. Market priors 58 can be evaluated using any variety of known statistical trading forecast algorithms in order to develop a plurality of sequences of possible market trends 64. For example, a Monte Carlo simulation method can be used for iteratively evaluating bounded random variations on market priors 58 such as assumed inflation rates, market movements, and portfolio returns. In some embodiments, the individual responses 56 can be used to force the Monte Carlo analysis so that the simulation of possible market trends 64 is biased toward an individual's expectations. Alternative trading forecast algorithms, which can be utilized for determining sequences of possible market trends 64, include artificial neural networks, exponential moving averages, predictive vector quantizations, Lempel-Ziv algorithms, distortion controlled algorithms, kernel regression, and multispectral algorithms. Preferably, multiple sequences of possible market trends 64 are determined for each possible life event 62.

At a step 96, the processor 16 estimates a financial consequence (expressed as an expected expense range 66) for each possible life event 62 based on the possible market trends 64. The expected expense ranges 66 can be expressed as present-value or future-value monetary amounts. For example, the expected expense range 66 of a possible health-care-related life event 62 may be driven upward by some possible market trends 64, but may also be held downward by other possible market trends 64. The high and low ends of the expected expense range 66 can be determined within a given confidence interval based on statistical analysis of the possible market trends 64. Similarly, the cost of raising and educating a child may be driven upward or held downward by yet other possible market trends 64 as well as by demographic data 60 or health-related individual responses 56.

Preferably, each expected expense range 66 is expressed as a range of future-value monetary amounts at a future time concurrent with the underlying possible life event 62, so that the plurality of expected expense ranges 66 can be expressed as a sequence of future-value monetary amount ranges. Additionally, the expected expense ranges 66 can be discounted by estimated likelihoods 98 of the corresponding possible life events 62.

At a step 100, the processor 16 calculates a time-varying individual need 68 based on the expected expense ranges 66. For example, the time-varying individual need 68 can be calculated by summing the likelihood-discounted future-value monetary amount ranges corresponding to the expected expense ranges 66 for all of the possible life events 62.

At a step 102, the processor 16 calculates probable return-on-investment ranges 72 for each of the plurality of investment vehicles 70 based on the possible market trends 64. Preferably, the return-on-investment range for each investment vehicle is determined in a granular, time-varying fashion, so that overall portfolio return-on-investment can be optimized by prospective rebalancing of portfolio value among the plurality of investment vehicles. Preferably, each return-on-investment range is determined by statistical analysis of a large set of relevant possible market trends 64. Monte Carlo analysis of the market priors 58 is the preferred mode for generating and analyzing large sets of possible market trends 64.

At a step 104, the processor 16 calculates an optimal sequence 106 of individual need allocations 74 among a plurality of investment vehicles 70 based on the possible market trends 64, the possible life events 62, and the return-on-investment ranges 72. Analysis also can be performed to identify the timing of a peak value of individual need 68, where a portfolio based on the optimal sequence 106 of individual need allocations 74 can shift over from a sustainable model to a sinking fund model.

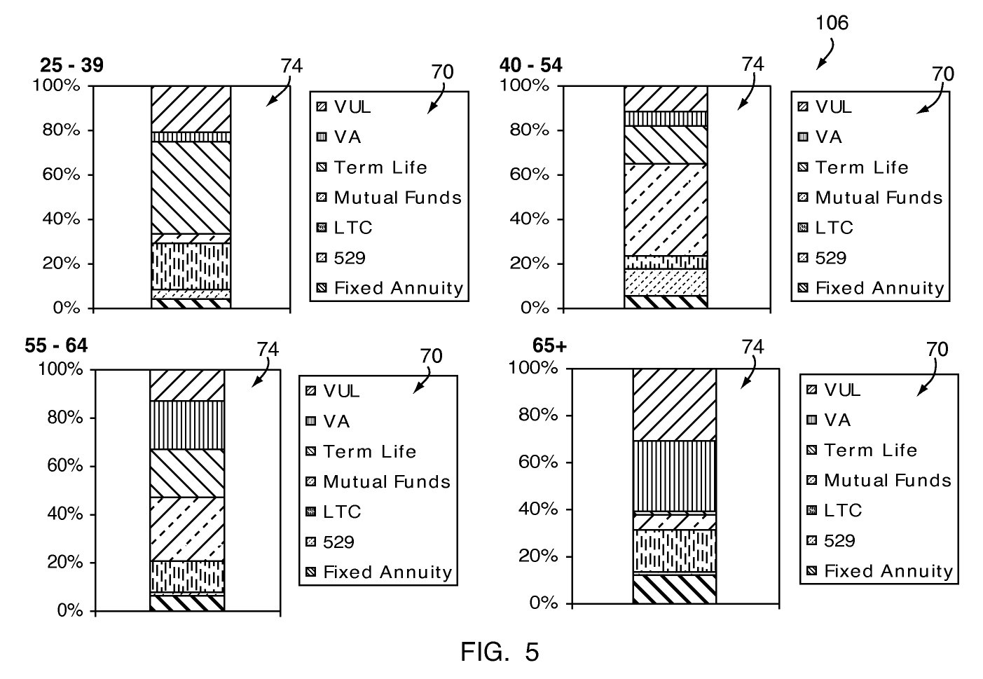

At a step 108, the processor 16 displays the optimal sequence 106 of individual need allocations 74 among investment vehicles using the display unit 24. For example, each individual need allocation 74 in the sequence 106 can be illustrated by a bar graph as shown in FIG. 5, where each segment of a bar indicates a portion of the individual need 68 that could be met by one of the recommended investment vehicles 70. The individual need allocations 74 also could be displayed as percentage tables or as absolute future-value monetary amounts. The individual responses 56 can include responses indicating preferred methods for funding various expected personal and family needs, and the optimal sequence 106 of individual need allocations 74 can be adjusted based on the individual responses 56.

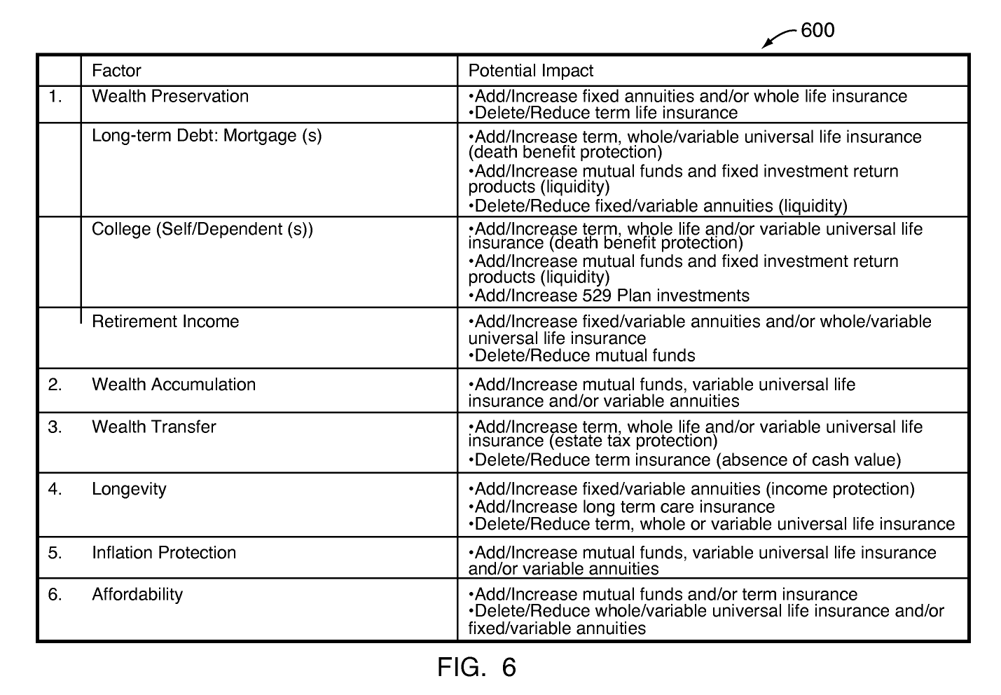

At a step 110, the processor 16 calculates an optimal sequence 112 of instructions for allocating investment inputs 76, based on the individual responses 56, the demographic data 60, the return-on-investment ranges 72, and the optimal sequence 106 of individual need allocations 74. For example, the optimal sequence 112 of instructions for allocating investment inputs 76 can be selected using various criteria such as a decision tree or a table of factors 600, as shown in FIG. 6. The individual responses 56 can include refusals of, or limitations on, investment inputs to specific investment vehicles 70. The optimal sequence 112 of instructions for allocating investment inputs 76 can be rebalanced according to the investment-vehicle-specific refusals or limitations.

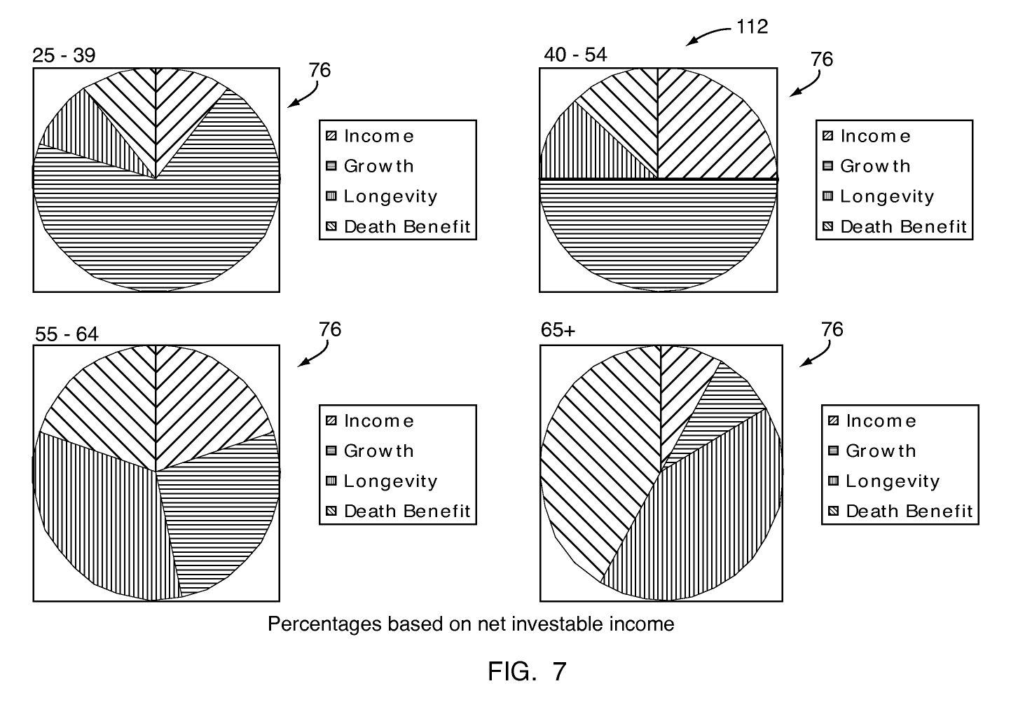

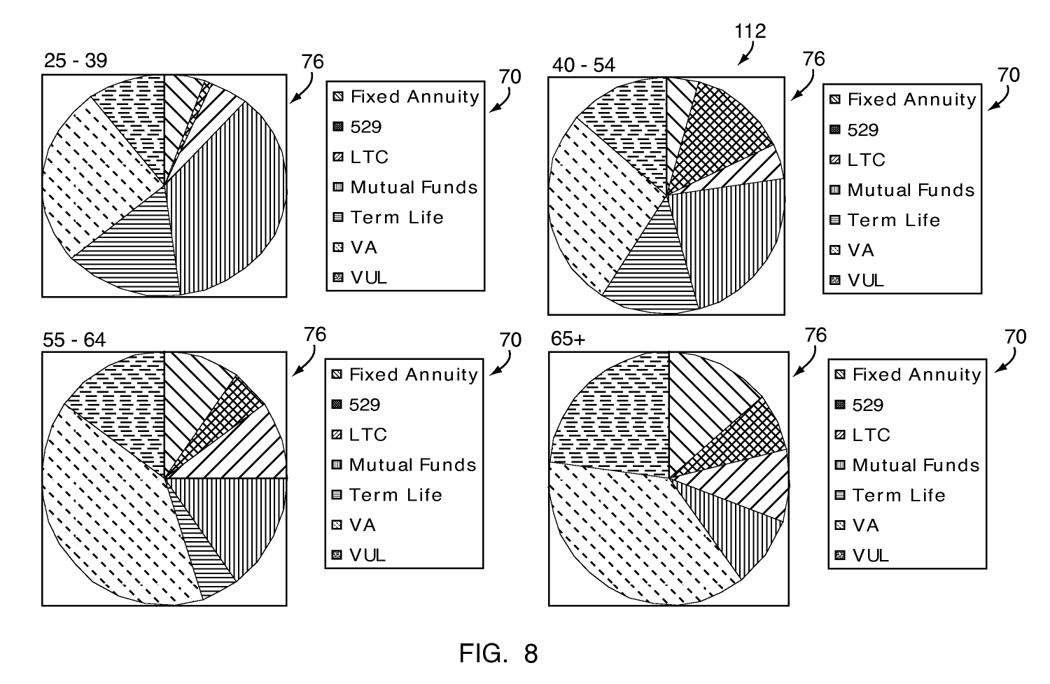

At a step 114, the processor 16 displays the optimal sequence 112 of instructions for allocating investment inputs 76 using the display unit 24. The optimal sequence 112 of instructions for allocating investment inputs 76 can be displayed using a purpose-labeled pie chart report, as shown in FIG. 7. Alternatively, the optimal sequence 112 of instructions for allocating investment inputs 76 can be displayed using a pie chart report labeled by investment vehicle 70, as shown in FIG. 8. The instructions for allocating investment inputs 76 also could be displayed as percentages or as absolute future-value monetary amounts.

The optimal sequence 112 of instructions for allocating investment inputs 76 and the optimal sequence 106 of individual need allocations 74 can be provided to the financial advisor 82 for use in administering an individual's portfolio. Alternatively, the optimal sequence 112 of instructions for allocating investment inputs 76 and the optimal sequence 106 of individual need allocations 74 can be encoded into the data structure 20 for automatically rebalancing investment assets and investment inputs.

As a specific example of how the process 10 can be used, a thirty (30) year old individual may provide individual responses 56 in the present day that closely correlate to a particular set of demographic data 60. Among other possible life events, the correlated demographic data 60 may show an eighty percent (80%) chance that the individual will need long-term inpatient medical care if the individual survives to age eighty (80). The demographic data may also show a five percent (5%) chance that the individual will live ten (10) or more years beyond entry into long-term inpatient care at age eighty. Based on a statistical analysis of possible market trends 64, ten years of long-term inpatient medical care fifty years in the future might have an expected expense range 66 of about $6M-$20M. Based on the possible market trends 64, and based on individual responses indicating expected available investment inputs of about $3M over the next fifty years, a narrow selection of high-risk, high-return investment vehicles 70 might be expected to achieve return-on-investment ranges 72 sufficient to cover the thirty year old individual's lowest value of the expected expense range 66 for long-term medical care. However, in determining the peak individual need 68 and the optimal sequence 112 of instructions for allocating investment inputs 76, the expected expense range 66 for long-term inpatient care can be discounted by the low combined likelihood that the thirty year old individual will (1) survive to age eighty; (2) require long-term inpatient care at age eighty; and (3) survive ten years beyond entry into long-term care. Thus, the optimal sequence 112 of instructions for allocating investment inputs 76 can aim for moderate risk and reliable returns while still meeting a reasonably discounted value of the individual need 68 for long term care expenses.

By performing similar probability analyses and estimates of expected expense ranges 66, individual needs 68, and instructions for allocating investment inputs 76 for each possible life event 62 in a large set of possible life events 62, the process 10 can produce a likely-scenario recommendation for an optimum sequence 112 of instructions for allocating investment inputs 76 in the form of a report such as shown in FIGS. 7 and 8.

One advantage of the present invention is that the process 10 provides a non-speculative basis for recommending diverse financial products that are most likely to meet the individual's present and future financial needs.

Another advantage of the present invention is that the investment vehicles 70 can be selected from a diverse and comprehensive list of asset types including fixed annuities, tax-deferred investments, mutual funds, direct equity investments, secured lending instruments, variable annuities and other sorts of “longevity insurance”, variable universal life insurance, term life insurance, property and casualty insurance, and umbrella liability insurance. For example, before reaching peak individual need 68, assets may be held primarily in mutual funds or equity investments. After peak individual need 68, assets may be realigned to cash-similar investments such as money market accounts or short-term certificates of deposit. Thus, investment assets can continually be re-aligned to investment vehicles appropriate to an individual's present and anticipated financial needs. By performing similar probability analyses and estimates of expected economic and social conditions, individual and family needs, and business needs, the process can also produce a recommendations for an optimum sequence of property and casualty coverage allocations such as between home, renters, automobile, umbrella, small business, commercial, etc. for the varying lifetime stages and events.

A further advantage of the present invention is that the system 12 can periodically and automatically repeat steps of the process 10 at predefined time intervals to provide automated review and modification of the optimal sequence 112 of instructions for allocating investment inputs 76. The system 12 also can issue instructions for buying, selling, or redeeming investment vehicles or portions of investment vehicles, according to the optimal sequence 112 of instructions for allocating investment inputs 76. Thus, the present invention enables an individual's overall portfolio to be automatically continually or periodically realigned, at predefined time intervals, to achieve a mix of investment vehicles 70 tailored to meet the individual's present and peak individual need 68.

Although this invention has been shown and described with respect to the detailed embodiments thereof, it will be understood by those skilled in the art that various changes in form and detail thereof may be made without departing from the spirit and the scope of the invention.

For example, the Monte Carlo method is just one of many possible sampling methods that may be used to illustrate how random variation, lack of knowledge, or error affects the sensitivity, performance, or reliability of the long term recommendations envisioned. As another example, while the preferred embodiment envisions use of data inputs that closely match publicly available data, proprietary demographic data and non-public market factors analyses can be incorporated into the process without departing from the broad concept of the present invention.

What is claimed is:

1. A system for automated periodic rebalancing of investment input allocations, comprising:
a data storage structure configured to store financial need data, market trend data, and instructions for allocating investment inputs among a plurality of investment vehicles; and
a computer processor configured to:
optimize the investment input allocations responsive to data indicative of estimated future financial needs and responsive to data indicative of predicted market trends; and
automatically modify the instructions for allocating investment inputs to an updated optimized investment input allocation at predefined time intervals,
wherein the investment vehicles include at least three of fixed annuities, deferred investments, mutual funds, direct equity investments, secured lending instruments, variable annuities, universal life insurance, term life insurance, educational savings plans, property and casualty insurance, and umbrella liability insurance.

2. The system according to claim 1, further comprising:
a display unit,
wherein said computer processor is further configured to display, via the display unit, said instructions for allocating investment inputs.

3. The system according to claim 1, further including an investment interface platform for executing instructions for the purchase of the investment vehicles in accordance with the updated optimized allocation.

4. The system according to claim 1, wherein said computer processor is further configured to modify said instructions for allocating investment inputs by reading from the data storage structure a plurality of individual responses to a standardized questionnaire, a set of demographic data, a plurality of market priors, and characteristics of said plurality of investment vehicles, correlating at least part of the set of demographic data to the individual responses, calculating a plurality of sequences of possible life events based on the individual responses and the demographic data, and a plurality of sequences of possible market trends based on the market priors, further calculating a time-varying individual need based on the plurality of possible sequences of life events and the plurality of sequences of possible market trends, and establishing said optimal sequence of instructions for allocating investment inputs based on the time-varying individual need, the characteristics of said plurality of investment vehicles, and the plurality of possible market trends.

5. The system according to claim 4, wherein said computer processor is further configured to calculate said time-varying individual need as a sum of expected expense ranges each corresponding to one of the plurality of possible life events, and is further configured to display said time-varying individual need as a sequence of bar charts displaying individual need allocations to each of said investment vehicles based on said plurality of sequences of possible market trends.

6. The system according to claim 5, wherein each of said expected expense ranges is calculated based on the corresponding possible life event and based on said plurality of sequences of possible market trends.

7. The system according to claim 4, wherein said computer processor is configured to determine each of said possible life events based on Monte Carlo analysis of said individual responses and said demographic data.

8. The system according to claim 4, wherein said computer processor is configured to determine each of said plurality of possible sequences of market trends based on Monte Carlo analysis of said market priors.

9. The system according to claim 4, wherein said individual responses include a total feasible investment allocation value and a plurality of outcome priorities, and said computer processor is further configured to modify said optimal sequence of instructions for allocating investment inputs based on the total feasible investment allocation value and the plurality of outcome priorities.

10. A computer-implemented method for life span solution-based modeling of recommended investment input allocations, comprising:
reading from a data storage structure a plurality of individual responses to a standardized questionnaire, a set of demographic data, a plurality of market priors, and characteristics of a plurality of investment vehicles;
correlating at least part of the set of demographic data to the individual responses;
calculating with the processor a plurality of sequences of possible life events based on the individual responses and the demographic data, and a plurality of sequences of possible market trends based on the market priors;
further calculating with the processor a time-varying individual need based on the plurality of possible sequences of life events and the plurality of sequences of possible market trends; and
establishing in the data storage structure an optimal sequence of instructions for allocating investment inputs based on the time-varying individual need, the characteristics of the plurality of investment vehicles, and the plurality of possible market trends,
wherein the investment vehicles include at least three of fixed annuities, tax-deferred investments, mutual funds, direct equity investments, secured lending instruments, variable annuities, variable universal life insurance, term life insurance, educational savings plans, property and casualty insurance, and umbrella liability insurance.

11. The method according to claim 10, further comprising:
displaying, via a display unit, at least one of said optimal sequence of instructions for allocating investment inputs and said individual need based on the plurality of possible sequences of life events.

12. The method according to claim 11, further comprising:
executing instructions for the purchase and/or sale of the investment vehicles in accordance with the updated optimized allocation.

13. The method according to claim 11, wherein said time-varying individual need is calculated as a sum of expected expense ranges each corresponding to one of the plurality of possible life events, and wherein said time-varying individual need is displayed as a sequence of bar charts displaying individual need allocations to each of said investment vehicles based on said plurality of sequences of possible market trends.

14. The method according to claim 13, wherein each of said expected expense ranges is calculated based on the corresponding possible life event and based on said plurality of sequences of possible market trends.

15. The method according to claim 13, wherein each of said possible life events is calculated based on Monte Carlo analysis of said individual responses and said demographic data.

16. The method according to claim 10, wherein each of said plurality of possible sequences of market trends is calculated based on Monte Carlo analysis of said market priors.

17. The method according to claim 10, further comprising:
periodically repeating said method at predefined time intervals.

18. The method according to claim 10, wherein said individual responses include a total feasible investment allocation value and a plurality of outcome priorities, the method further comprising:
modifying said optimal sequence of instructions for allocating investment inputs based on the total feasible investment allocation value and the plurality of outcome priorities.

19. A computer-readable medium encoded with instructions for configuring a computer processor to
read from a data storage structure a plurality of individual responses to a standardized questionnaire, a set of demographic data, a plurality of market priors, and characteristics of a plurality of investment vehicles;
correlate at least part of the set of demographic data to the individual responses;
calculate a plurality of sequences of possible life events based on the individual responses and the demographic data, and a plurality of sequences of possible market trends based on the market priors;
further calculate a time-varying individual need based on the plurality of possible sequences of life events and the plurality of sequences of possible market trends; and
establish an optimal sequence of instructions for allocating investment inputs based on the time-varying individual need, the characteristics of the plurality of investment vehicles, and the plurality of possible market trends,
wherein the investment vehicles include fixed annuities, tax-deferred investments, mutual funds, direct equity investments, secured lending instruments, variable annuities, variable universal life insurance, term life insurance, property and casualty insurance, and umbrella liability insurance.

20. The computer-readable medium according to claim 19, further encoded with instructions for configuring said processor to display, via a display unit, at least one of said optimal sequence of instructions for allocating investment inputs and said individual need based on the plurality of possible sequences of life events.

21. The computer-readable medium according to claim 20, further encoded with instructions for configuring said processor to execute said instructions for allocating investment inputs by selling and/or purchasing said investment vehicles.

22. The computer-readable medium according to claim 20, further encoded with instructions for configuring said processor to calculate said time-varying individual need as a sum of expected expense ranges each corresponding to one of the plurality of possible life events, and is further configured to display said time-varying individual need as a sequence of bar charts displaying individual need allocations to each of said investment vehicles based on said plurality of sequences of possible market trends.

23. The computer-readable medium according to claim 22, further encoded with instructions for configuring said processor to calculate said expected expense ranges based on the corresponding possible life event and based on said plurality of sequences of possible market trends.

24. The computer-readable medium according to claim 22, further encoded with instructions for configuring said processor to determine each of said possible life events based on Monte Carlo analysis of said individual responses and said demographic data.

25. The computer-readable medium according to claim 19, further encoded with instructions for configuring said processor to determine each of said plurality of possible sequences of market trends based on Monte Carlo analysis of said market priors.
